(19) United States
(12) Patent Application Publication
(10) Pub. No.: US 2021/0138279 A1
(43) Pub. Date: May 13, 2021

(54) Anti-virus filter for facemasks and respirators

(71) Applicant: Ramesh Gopalan, Fremont, CA (US)

(72) Inventor: Ramesh Gopalan, Fremont, CA (US)

(21) Appl. No.: 17/147,546

(22) Filed: Jan. 13, 2021

Related U.S. Application Data
(60) Provisional application No. 63/019,372, filed on May 3, 2020.

(51) Int. Cl. A62B 23/02; B01D 46/00; B01D 39/16; A41D 13/11; A62B 7/10

(52) U.S. Cl. CPC A62B 23/02; B01D 46/0036; B01D 39/16; B01D 2239/065; A62B 7/10; B01D 2239/0291; A41D 13/1192

(57) ABSTRACT

This invention is to an anti-virus filter which may included in a facemask, personal protective equipment, respirator or ventilator to protect against airborne pathogens including the novel coronavirus. It is comprised of one or more anti-virus layers comprising a superabsorbent polymer which converts to a hydrogel upon addition of a water solution containing soap or detergent. The anti-virus layer is enclosed between an outer layer and an inner layer both of which are permeable to air but impermeable to water.

### CROSS-REFERENCE TO RELATED APPLICATIONS

Priority is claimed to provisional application 63/019,372 filed 2020 May 3, titled ‘A facemask for protection against airborne pathogens’ and naming Ramesh Gopalan as inventor.

### FIELD OF THE INVENTION

This invention pertains to providing a filter in personal protective equipment, respirators, ventilators and other breathing equipment to protect against coronaviruses and other airborne pathogens causing infection by entering human airways through nose and mouth.

### BACKGROUND OF THE INVENTION

Face Masks are commonly used to prevent the spreading of viral respiratory infections in human populations. The breathing air supplied by respirators or ventilators to patients affected by respiratory ailments is typically cleaned or purified of particulates and airborne pathogens by scrubbing or cleaning it through a HEPA—High Efficiency Particulate Air or HEPA filter. The expired air is similarly scrubbed by a similar filter to remove viruses preventing further infection of others in the proximity of the patient. Many viruses such as the novel coronavirus SARS-COV2 causing the worldwide pandemic disease COVID-19 beginning in 2019 and continuing through 2021 consist of very small particles, each with a spherical shell comprised of fatty protein or lipid protein, with surrounding ‘crown spikes’ comprised of glycoprotein, enclosing the virus' genetic material or RNA. These viruses are among the smallest pathogens causing human disease. The novel coronavirus for example is less than about one-fifth of a micron—millionths of a meter—in size, but is typically transmitted in droplets of human mucus or saliva emitted from the infected person during sneezing, coughing or even speaking or breathing. Typically, these virus-laden droplets are larger, few microns in size, and fall to the ground under gravity over a distance of over several feet—this provides a prescription for social distancing as a means of preventing the spread of the infecting virus from one person to another. However, mucus or saliva are 95% water and these virus-laden droplets can evaporate easily releasing the viruses as airborne or aerosol particles which can be carried through air currents to cause infection in persons well beyond the range of social distancing.

The novel coronavirus COVID-19 or SARS-COV-2 is highly contagious, with a fatality rate of few percent and spreading to affect nearly 100 million people and causing over 2 million deaths worldwide as of January 2021. Even as vaccines are in production and being distributed new variants of these and other viruses will remain a threat to the global public health, having already caused a catastrophic shock to the world economy as bad as seen during the Great Depression almost a century ago. It is extremely important to develop face masks and other personal protective equipment, respirators and ventilators that will ensure adequate protection against this type of virus and allow non-infected persons to return to work, stay healthy and rejuvenate the economy now in a world-wide humanitarian crisis.

### DESCRIPTION OF RELATED AND PRIOR ART

Face-masks are commonly used to protect against viral or other particulate pollution entering through the human mouth and nose to the airways to the lungs. The gold standard for masks is the N95: the specification for this mask provides that it prevents entry of 95% of particles above the size of 0.3 microns into the wearer's nose or mouth [Reference 1—www.fda.gov] This specification is clearly inadequate since the novel coronavirus is significantly smaller than this smallest ‘pore’ size of the mask allowing the possibility that airborne or aerosolized virus particles only 0.16 microns in size can penetrate the surface cover of the mask and enter the airways of the wearer, causing infection. Other masks, or cloth wrappings, are even less effective: for instance a single layer of 500-thread count cotton cloth can have up to 5-10 microns of spacing between threads through which the individual virus particles may enter easily. Doubling up on these layers does not significantly improve the protection, while making it more difficult to breathe through the mask.

A similar limitation affects ventilators or respirators that provide infection-free breathing air to patients affected by respiratory and cardio-vascular ailments including COVID-19 or SARS-COV2 and also the air expired or exhausted from such breathing equipment to ambient air. To prevent the spread of often life-threatening infections, the exhaled or exhausted air must cleaned or purified of any pathogens from the infected person before it can be safely re-introduced to ambient air. Such supply or exhausted air is currently purified by High Efficiency Particulate Air or HEPA filters which, at best, remove 99.97% of particles that are larger than 0.3 microns in size. [Reference 2—www.cdc.gov]. Again here, the challenge is that the novel coronavirus causing the worldwide pandemic of 2019-2021, at only 0.16 microns, is smaller than this specification and therefore not guaranteed to be filtered out of the air.

COVID-19 cases have continued to rise unabated even in U.S. states and countries that have mandated the use of masks in all public places: this is further evidence that the common masks are not adequately effective in preventing the spread of highly contagious airborne viruses.

### DETAILED DESCRIPTION OF THE INVENTION

It appears difficult or impossible to engineer masks or filters with pore size less than the typical virus size of about 0.1 microns while still allowing adequate natural breathing for the wearer. The focus of this invention is on de-activating the virus soon after it contacts the front side or air input side of the mask or ventilator and before it can migrate to the face and airways of the person. The same filter may be used to purify the expired or exhaust air from ventilators to ensure that no infecting particles are transmitted to ambient air which is available to uninfected persons. Here we take instruction from the most common preventive measure against viruses and other pathogens: washing hands with soap. Although the novel coronavirus may be killed or de-activated by disinfectants like alcohol or bleach it is preferable to use the more common, benign substance like household soap or detergent. Soap has molecules which combine a hydrophilic or water-loving ‘head’ and a hydrophobic or water-avoiding ‘tail’. When a water-based soap solution comes in contact with the coronavirus the hydrophobic tails of the soap molecule breach the oily protein or lipid-protein shell of the virus causing its destruction into non-functional components, including the genetic RNA core, which are then surrounded by soap molecules and washed away with their hydrophilic ends drawing them away into the surrounding water. The virus components stay in the aqueous solution, unable to re-assemble into viable viruses, until they are washed away or otherwise disposed, preventing any chance of further infection.

Any face mask or filter that uses this concept must include a layer of soapy water—dilute soap solution—in between the external surface of the mask or air input side of the ventilator and the inner surface of the mask adjacent to the face, mouth and nose of the person wearing the mask or breathing equipment. Yet is also important to keep dry both the inside surface layer in contact with skin and the external or outside surface layer of the mask. Equally important is that all these layers of the mask or filter must be permeable to air enough to allow adequate natural breathing by the wearer. These requirements are already met in a common product in routine use while in close contact with humans: the disposable diaper. A disposable diaper includes one or more absorbent layers which contain benign, inert materials like cellulose fibers and water-absorbing polymers such as sodium polyacrylate. These belong to the class of substances known as superabsorbent polymers (SAP) or ‘slush powder’. These provide the remarkable ability to absorb prodigious amounts of water, up to few hundred times their weight, while converting to a moist hydro-gel which is a hydrophilic polymer network formed through hydrogen bonding with the water molecules critically does not release or leak water. A further useful property of this gel is that even with substantial water absorption it remains a porous network which allows air to permeate through it.

In our invention the face mask or anti-virus filter would include a similar absorbent layer which would be saturated with a soap solution while still maintaining adequate permeability of air to allow natural breathing through it. The porosity, or pores, in this layer would need to be configured so that any virus or pathogen would have a convoluted or maze-like path from the outside to the inside surface of the mask. This would ensure that the virus would have come into repeated contact with water and soap molecules in the absorbent hydrogel so that it becomes de-activated or rendered non-viable as an agent of infection. While the virus would be drawn inward to the face with every inhalation (and pushed out by every exhalation) the purpose of the soap-saturated hydrogel would be to achieve the same effect as the ‘20-seconds’ prescribed for hand-washing to render the virus ineffective. Since every typical breath inhalation-exhalation lasts from few to several seconds this naturally prescribes the needed thickness, absorbent hydro-gel density, and needed porosity of the absorbent layer.

These may be optimized by computer modeling or more reliably by actually testing with a variety of combinations to ensure that nearly all viruses incident upon the front or external surface of the mask are rendered inactive if and when their non-functioning fragments emerge on the inside or internal surface of the mask located next to the skin, nose and mouth of the wearer's face.

Even without need for complex computer modeling a simple calculation provides the necessary specifications to ensure adequate protection against the viruses at low-cost. To decide how much soap-solution to add to absorbent material these calculation steps are instructive: The absorbent material in a typical diaper is also about 1-3 mm thick and about ˜100 cm2 in area, accounting for a volume of about 10 cubic centimeters or milliliters—this volume is adequate to provide adequate coverage for a facemask as exemplary embodiment of this invention. It is well-known that this absorbent material is mostly air, and can absorb up to few hundred times its weight in water or water-based solutions, while swelling in volume only slightly. This is not surprising, considering that water is about 1000 times denser than air. We have found the following rule-of-thumb estimates useful to determine the amount of soap to be added to water and subsequently added as soapy solution to the absorbent layer to create a moist (but not wet) hydrogel with adequate density of soap and water molecules to ensure that any virus particle entering from the ‘front’ of the filter becomes inactivated or destroyed before it can exit the ‘back’ of the filter which is to be located nearer the person's airways. The absorbent layer may be fabricated by adding about 10-12 cc (ml) of soapy solution to be absorbed uniformly in about 10 cc of superabsorbent polymer material such as derived from a common unused disposable diaper. The 10 cc of soap solution may be made in the following proportion—mixing about 10 cc of distilled or pure water with 0.5 teaspoon or 2-3 cc of liquid hand soap or equivalent detergent. When soap solution in the ratio of soap to water about 1:5 is thus added in the ratio of about 1:1 by volume of absorbent material, we achieve a hydrogel that is feels slightly moist but not wet and simple calculations show that any pathogen particle entering such a hydrogel layer 1-3 mm thick will have a mean-free path of less than 0.1 micron diameter of the virus itself and thus necessarily collide with millions of soap and water molecules before it can traverse from the front or external surface to the back or internal surface of the filter. This ensures that each and every virus particle is deactivated and destroyed before it can cause infection. This anti-virus layer thus provides an impenetrable moat against the pathogens that may otherwise enter the airways and lungs of the patient or person.

The face mask will need to be dry both on the inside and outside surfaces. This is also easily achieved by existing solutions such in the common diaper, the outer layer of which is comprised of inert plastic sheet and other stain-resistant coatings such as applied to clothing apparel in common, daily use. This method is also common in Nature: the duck spends its life on water but manages to keep its feathers and wings dry enough to be able to fly. In the case of our protective face mask, or anti-virus filter the absorbent layer comprising the anti-virus layer would have both sides—the inner and outer surfaces—provided with such a waterproof layer which is permeable to air but impermeable to water.

It will be clear to those familiar with the art that here is described a anti-virus filter including an anti-virus layer which may be incorporated as needed into a variety of protective facemasks, personal protective equipment, ventilators and other breathing equipment intended to supply air cleansed of viruses or other pathogens to any environment where healthy, breathing air is required.

### DESCRIPTION OF THE DRAWINGS

The drawings depict the operation of typical embodiments of the invention.

FIG. 1—a cross-section schematic depicting the inclusion of the anti-virus layer into an anti-virus facemask.

FIG. 2—a cross-section schematic depicting the inclusion of the anti-virus layer into a respirator or ventilator filter housing to clean inhaled or exhaled air by de-activating viruses and other harmful pathogens as it is passed through the anti-virus filter layer.

### SUMMARY OF THE INVENTION

In summary, this invention is for an anti-virus filter which may included in a facemask, personal protective equipment, respirator or ventilator to protect against airborne pathogens including the novel coronavirus. It is comprised of one or more anti-virus layers comprising a superabsorbent polymer which converts to a hydrogel upon addition of a water solution containing soap or detergent. The anti-virus layer is enclosed between an outer layer and an inner layer both of which are permeable to air but impermeable to water.

### REFERENCES

1. https://fda.gov/medical-devices/personal-protective-equipment-infection-control/n95-respirators-surgical-masks-and-face-masks
2. https://www.cdc.gov/infectioncontrol/guidelines/environmental/background/air.html

1. An anti-virus filter to protect against airborne pathogens
said anti-virus filter including an anti-virus layer placed between an inner layer adjacent to wearer's nose and mouth and
an outer layer
said inner layer and outer layer being permeable to air and impermeable to water
said anti-virus layer comprised of an absorbent layer which is further comprised of materials chosen from the class of superabsorbent polymers including sodium polyacrylate
such that said absorbent layer is capable of forming a hydrogel when a water-based solution of one or more substances chosen from: soap, detergent, surfactants is added to the absorbent layer.

2. An item of personal protective equipment comprising the said anti-virus layer of claim 1

3. A ventilator for providing breathing air comprising the anti-virus layer of claim 1.

4. A respirator comprising the anti-virus layer of claim 1
